(19) United States
(12) Patent Application Publication
(10) Pub. No.: US 2023/0150462 A1
(43) Pub. Date: May 18, 2023

(54) VIBRATION BASED MU DETECTION

(71) Applicants: Steering Solutions IP Holding Corporation, Auburn Hills, MI (US); Continental Automotive Systems, Inc., Auburn Hills, MI (US)

(72) Inventors: Omkar Karve, Farmington Hills, MI (US); Michael Wyciechowski, Grand Blanc, MI (US); Jason Brian Schwegler, Grand Blanc, MI (US)

(73) Assignees: Steering Solutions IP Holding Corporation, Auburn Hills, MI (US); Continental Automotive Systems, Inc., Auburn Hills, MI (US)

(21) Appl. No.: 17/528,115

(22) Filed: Nov. 16, 2021

(51) Int. Cl. B60T 8/172; B60T 8/174; B60T 8/171; B60T 8/1763

(52) U.S. Cl. CPC B60T 8/172; B60T 8/174; B60T 8/171; B60T 8/1763; B60T 2210/12; B60T 2210/36; B60T 2250/04

(57) ABSTRACT

A system and method of mu estimation may include the steps of collecting vehicle travel data on a road surface via a plurality of a sensors including at least one of an accelerometer or microphone; collecting external source data over a network; and aggregating the vehicle travel data and external source data to form an aggregated data set. The method may include performing feature extraction processing of the aggregated data set to transform the aggregated data set and into a processed aggregated data set; communicating the processed aggregated data set to a machine learning model; and generating at least one of an estimated mu value of the road surface or road surface classification via the machine learning model.

### TECHNICAL FIELD

The field to which the disclosure generally relates includes systems for estimating coefficients of friction between a road surface and a tire surface.

### BACKGROUND

Coefficient of friction, commonly referred to as mu or p, is a ratio indicating frictional force present between two objects. In the case of vehicles, mu may represent the dynamic frictional force present between a road surface and a vehicle wheel when a vehicle is in motion. Mu may be estimated between a road surface and a vehicle wheel when slip conditions exists such as application of anti-lock braking systems, or from lateral mu estimation systems when wheels are turned by changing the steering angle of a vehicle. Slip conditions and lateral friction may not occur simultaneously and at times, little-to-no slip conditions or lateral friction may exist during use of a vehicle. Therefore, mu may not be easily determined during certain driving situations and operating environments.

### SUMMARY OF ILLUSTRATIVE VARIATIONS

A number of illustrative variations may include a method or product for accurate mu value estimation and generation for various road surfaces, operating environments, and driving scenarios by monitoring acoustic signals and vibration signatures. Acoustic signals and vibration signatures may be used to perform feature extraction signal processing techniques and further processed and transformed to generate mu values.

A system and method of mu estimation may include collecting vehicle travel data on a road surface via a plurality of a sensors; performing feature extraction processing of the vehicle travel data to transform the vehicle travel data into processed vehicle travel data; communicating the processed vehicle travel data to a machine learning model; and generating at least one of an estimated mu value of the road surface or road surface classification via the machine learning model.

A system and method of mu estimation may include the steps of approximately continuously collecting vehicle travel data on a road surface via a plurality of a sensors including at least one of an accelerometer or microphone; approximately continuously collecting external source data over a network; aggregating the vehicle travel data and external source data to form an aggregated data set; performing feature extraction processing of the aggregated data set to transform the aggregated data set and into a processed aggregated data set; communicating the processed aggregated data set to a machine learning model; and generating at least one of an estimated mu value of the road surface or road surface classification via the machine learning model.

A system for vibration base mu estimation may include at least one computing device in operable connection with a network; a memory that stores computer-executable components; and a processor that executes the computer-executable components stored in the memory. The computer-executable components may include approximately continuously collecting vehicle travel data on a road surface via a plurality of a sensors; approximately continuously collecting external source data over the network; performing feature extraction processing of the vehicle travel data and external source data to transform the vehicle travel data and external source data into processed vehicle travel data and processed external source data; communicating the processed vehicle travel data and processed external source data to a machine learning model; and generating at least one of an estimated mu value of the road surface or road surface classification via the machine learning model.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts a block diagram of a system for vibration-base mu detection and estimation;

FIG. 2 depicts a block diagram of a system for vibration-base mu detection and estimation;

FIG. 3 depicts a block diagram of a system for vibration-base mu detection and estimation; and

FIG. 4 depicts an illustrative flowchart of one variation of a system for vibration-base mu detection and estimation.

### DETAILED DESCRIPTION OF ILLUSTRATIVE VARIATIONS

The following description of the variations is merely illustrative in nature and is in no way intended to limit the scope of the invention, its application, or uses.

As used herein, the term “approximate” and variations on that term indicate that measurements, positions, timing, or the like allows for some imprecision in a value i.e. with some variation in exactness in a value; about or reasonably close to a value; or nearly. If, for some reason, the imprecision provided by “approximate” is not otherwise understood in the art with this ordinary meaning, then “approximate” as used herein indicates at least variations that may arise from ordinary methods of measuring or using such parameters.

As used herein, “wheels” or “wheel,” even when modified by a descriptive adjective such as but not limited to in the recitation of “steerable roadwheels,” “steerable wheels,” “road wheels,” or “driven wheels,” may refer to a traditional road wheel and tire arrangement, but may also refer to any modification to the traditional road wheel and tire arrangement such as but not limited to rimless mag-lev tires, ball tires, or any other known means of automotive movement wherein the wheel or wheels are in at least partial contact with a road surface.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

As used herein, “operating environment” may refer broadly to roadways, highways, streets, paths, parking lots, parking structures, tunnels, bridges, traffic intersections, residential garages, or commercial garages. It is contemplated that the operating environment may include any location or space accessible by a vehicle.

As used herein, “computing device” or “computer” may refer broadly to a system constructed and arranged to execute the processes and steps described in this disclosure. A computer device may include one or more processors in operable communication with memory through a system bus that couples various system components such as input/output (I/O) devices. Processors suitable for the execution of computer readable program instructions or processes may include both general and special purpose microprocessors and any one or more processors of any digital computing device. A computing device may include standalone computer or mobile computing device, a smart device, a mainframe computer system, a workstation, a network computer, a desktop computer, a laptop, or the like. A computing device maybe a combination of components including a processor, memory, data storage, and the like in operable communication with a variety of systems within a vehicle such as, but not limited to, electronic steering systems, traction control systems, autonomous and semi-autonomous driving systems, or the like.

In a number of illustrative variations, slip control systems such as but not limited to a traction control system (TCS) or engine stability control (ESC) may be used to prevent a vehicle's wheels from spinning, due to a low surface friction coefficient, when torque is delivered to the wheels. Slip control systems may therefore be used to promote vehicle stability by selectively delivering power to the wheels based upon sensed slippage of the wheels, thus preventing unintended imbalances in driving force delivered from each wheel to the vehicle.

In a number of illustrative variations, slip control systems such as, but not limited to, anti-lock braking systems (ABS) may be user to prevent a vehicle's wheels from locking, due to a low surface friction coefficient, when braking. Electronic Braking Distribution (EBD) may also be used to adjust the bias between the rear brakes and front brakes or left brakes and right brakes. Slip control systems may therefore be used to promote maintained steering control by selectively braking the wheels based upon sensed slippage of the wheels, thus preventing unintended imbalance in braking force delivered from each wheel to the vehicle.

In a number of illustrative variations, a steering system may comprise an autonomous slip control system incorporating TCS, ESC, ABS, EBD, or the like. In such illustrative variations, the slip control system may be integrated into or communicate with the vehicle control systems of the autonomous steering system including but not limited to the propulsion systems including but not limited to engine control systems, braking control systems, and vehicle steering systems.

In a number of illustrative variations, the surface friction coefficient, which may also be called the coefficient of surface friction, surface adhesion coefficient, or surface friction factor may be used as a metric for the amount of force that may be transmitted between a driving surface and a wheel of a vehicle. The coefficient of friction, or mu value, may be estimated by the system via a plurality of sensors and systems constructed and arranged to continuously monitor road and vehicle conditions, in addition to receiving information from external sources, such that systems within a vehicle may compensate for estimated mu value and road surface classification.

A number of illustrative variations may include a method or product for accurate mu value estimation and generation for various road surfaces, operating environments, and driving scenarios by monitoring acoustic signals and vibration signatures. Acoustic signals and vibration signatures may be used to perform feature extraction signal processing techniques such as, but not limited to, utilizing Mel filter banks for acoustic signals or continuous wavelet transform (CWT) for vibration signals. Acoustic signals and vibration signatures may be further processed and transformed via a pre-trained machine learning model or neural network to generate estimated mu values. Estimated mu values may be communicated to vehicle systems, such as slip control systems, to compensate for variations in mu values or road surface classifications.

A system for mu value estimation may include monitoring or recording acoustics signals by at least one microphone disposed approximately within a wheel well of a vehicle or other suitable locations suitable for measuring sounds pressure. The system may incorporate various other data sets from various other sources such as tire-pressure monitoring systems (TPMS), road surface data, GPS position data, weather data, and the like. It is contemplated that other products and methods for mu estimation fall within the scope of this disclosure and the variations described herein, including at least one microphone, shall not be considered limiting with respect to how sound pressure is measured. The system may aggregate data such as accelerometer-based vibration signals, acoustic pressure signals, TPMS data, and the like to process the various signals and data which may be fed to a pre-trained machine learning model to generate a mu value for a road surface in a particular driving scenario.

The system for mu value estimation may include at least one accelerometer positioned approximately near the steering knuckle or alternatively near, or as a part of, a tire-pressure sensor may monitor or record vibration signatures in the wheel, steering assembly, or various other parts and portions of a vehicle. It is contemplated that other products and methods for mu estimation fall within the scope of this disclosure and the variations described herein, including the use of accelerometers, shall not be considered limiting with respect to how vibration signature is measured, monitored, or recorded.

At least one microphone may be in operable communication with at least one computing device constructed and arranged to receive acoustic signals observed by the at least one microphone. The at least one accelerometer may also be in operable communication with the at least one computing device, the at least one computing device being constructed and arranged to receive vibration signatures monitored or recorded by the at least one accelerometer.

The system for vibration based mu estimation and detection may further include a contact sensor system constructed and arranged to detect and classify varying sound signals such as low-speed impacts.

The system for vibration-based mu estimation and detection may be in operable communication with a network such as a vehicle-to-everything (V2X) network such that the system may receive road data including road surface information, GPS vehicle position data, weather and climate data, and various other information. Externally sourced data received by the system may be used to determine road surface classification in addition to generating a mu value.

The system may further account for various factors such as inflation within the tires of a vehicle, snow or dirt packing within the wheel wells of a vehicle, varying tire types such as summer, winter, all season, etc. such that the generated mu value may be continuously tuned based on a vehicle's particular response within a given driving situation where differing move performance is detected.

The system for mu value estimation may receive the aforementioned datasets and perform feature extraction signal processing techniques such as utilizing Mel filter banks for acoustic signals or continuous wavelet transforms for vibration signals such that the processed data sets may be fed to a pre-trained machine learning module constructed and arranged to generate a mu value. Feature extraction and computation of mu values may occur locally within a computing device within a vehicle or may occur via the V2X network on a cloud-based computing system. The machine learning module may classify road type and generate a mu value using regression-based neural networks and may be constructed and arranged to reduce noise in dataset by identifying unique feature variations. The pre-trained machine learning module may generate a road surface classification and mu estimation in addition to various other outputs such as tire wear warnings. Road surface classification and mu estimation may further be used to generate a qualified mu number based on chassis performance assessment. Additionally, the system may compare historical data based on GPS vehicle location, V2X data, and mu estimations to current GPS vehicle location, V2X data, and mu estimations to continually tune value thresholds for mu estimation.

The system for mu value estimation may collect data from test vehicles where a fleet of test vehicles with known combinations of tire and chassis arrangements may be operating in a test fleet and data may be collected via a plurality of sensors in each vehicle of the test fleet. Collected data may be uploaded to a central server where the data may be matched with the known mu values for the known combinations of tire and chassis arrangements for each individual vehicle. Matched data may be fed to a machine learning model using the transformation such as, but not limited, feature extraction via Mel filter banks or continuous wavelet transforms0 in addition to other feature extraction methods. The machine learning model may then be trained to generate outputs as per the training data and tested using new available previously unseen data. This data may include accelerometer-based vibration signals, acoustic pressure signals, TPMS data, road surface information, GPS vehicle position data, and weather and climate data which will be available during normal operations of the vehicle in the field.

Data sets may further be manipulated to generate a confidence number associated with accelerometer-based vibration signals, acoustic pressure signals, TPMS data, road surface information, GPS vehicle position data, and weather and climate data.

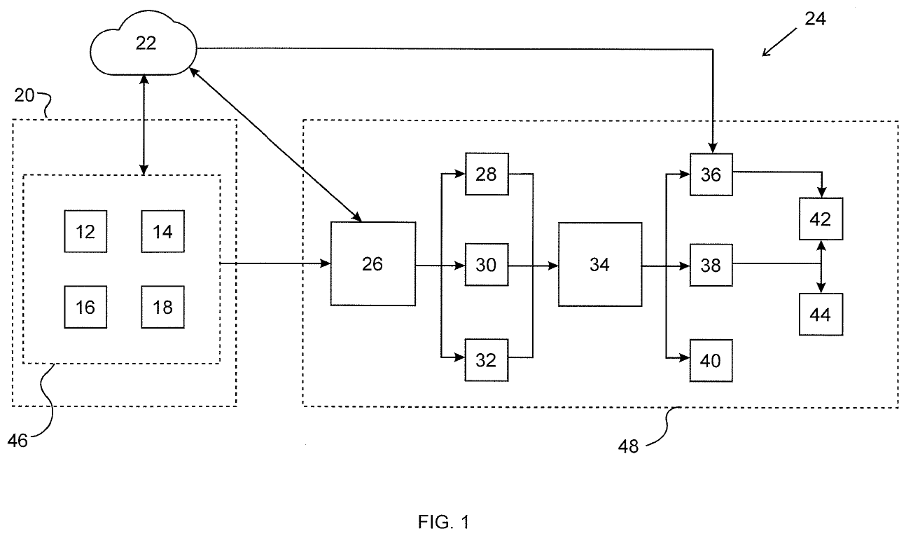

Referring to FIG. 1, as a non-limiting example, a vibration-based mu detection system 24 may include at least one computing device 20 in operable communication with a plurality of sensors 46. The plurality of sensors 46 may include an accelerometer 12, a microphone 14 constructed and arranged for acoustic pressure sensing, a contact sensor system 16, and a tire pressure monitoring system 18. The at least one computing device 20 may be in communication with various other sensors on a vehicle. The at least one computing device 20 may be in operable communication with a network 22 and a second computing device 48. The at least one computing device 20 may receive various datasets from external sources via the network 22, such as road surface data, GPS position data, weather data, or the like. Alternatively, the at least one computing device 20 may receive various datasets such as road surface data, GPS position data, weather data, and the like from additional sensors and systems on board a vehicle.

The second computing device 48 may receive sensor data via the network 22 and from the at least one computing device 20. The second computing device 48 may process received data via feature extraction 26 via Mel filter banks 28 or continuous wavelet transforms 30 in addition to other feature extraction methods 32. process data may be communicated to a pre trained machine learning model 34 constructed and arranged to classify road type 36, generate a mu value 38, and generate tire wear warnings 40 in a vehicle. Road type 36 and mu value 38 may further be processed to qualify the mu value 38 based on assessment of chassis performance. The mu value 38 may further by processed and compared to historical data relating to a vehicles current location as determined by GPS or received via the network 22 to further qualify mu value 38 to generate a road surface classification 42 and to generate a refined mu value 44.

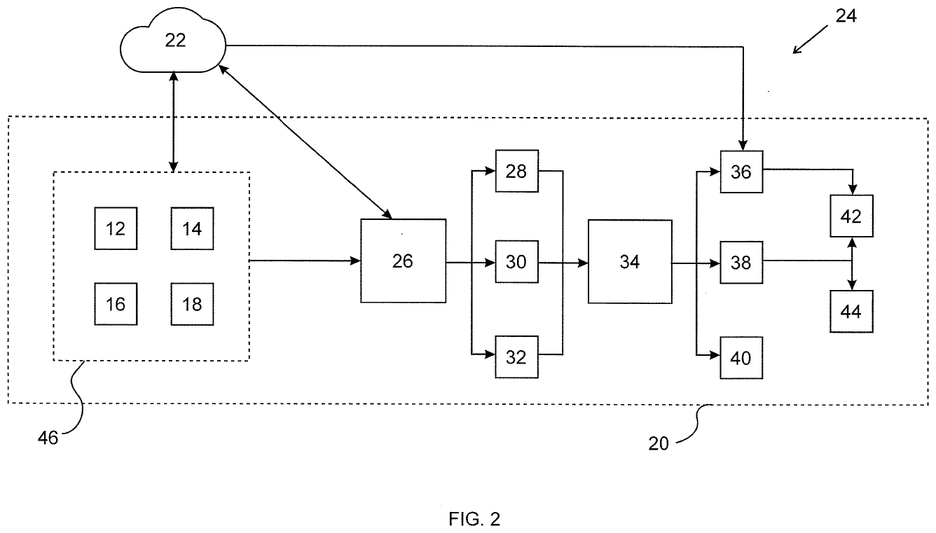

Referring to FIG. 2, as a non-limiting example, a vibration-based mu detection system 24 may include at least one computing device 20 in operable communication with a plurality of sensors 46. The plurality of sensors 46 may include an accelerometer 12, a microphone 14 constructed and arranged for acoustic pressure sensing, a contact sensor system 16, and a tire pressure monitoring system 18. The at least one computing device 20 may be in communication with various other sensors on a vehicle. The at least one computing device 20 may be in operable communication with a network 22. The at least one computing device 20 may receive various datasets from external sources via the network 22, such as road surface data, GPS position data, weather data, or the like. Alternatively, the at least one computing device 20 may receive various datasets such as road surface data, GPS position data, weather data, and the like from additional sensors and systems on board a vehicle.

The at least one computing device 20 may receive sensor data via the network 22 and from the at least one computing device 20. The at least one computing device 20 may process received data via feature extraction 26 via Mel filter banks 28 or continuous wavelet transforms 30 in addition to other feature extraction methods 32. process data may be communicated to a pre trained machine learning model 34 constructed and arranged to classify road type 36, generate a mu value 38, and generate tire wear warnings in a vehicle. Road type 36 and mu value 38 may further be processed to qualify the mu value 42 based on assessment of chassis performance. The mu value 38 may further by processed 44 and compared to historical data relating to a vehicles current location as determined by GPS or received via the network 22 to generate a road surface classification 42 and to generate a refined mu value 44.

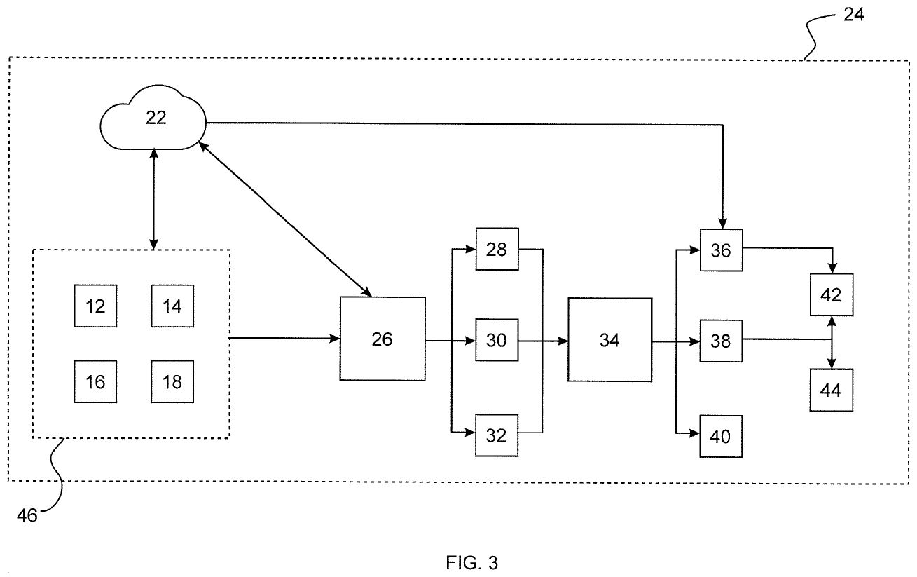

Referring to FIG. 3, as a non-limiting example, a vibration-based mu detection system 24 may include at least one computing device 20 in operable communication with a plurality of sensors 46. The plurality of sensors 46 may include an accelerometer 12, a microphone 14 constructed and arranged for acoustic pressure sensing, a contact sensor system 16, and a tire pressure monitoring system 18. The at least one computing device 20 may be in communication with various other sensors on a vehicle. The at least one computing device 20 may be constructed and arranged for network connectivity 22. The at least one computing device 20 may receive various datasets from on-board sources such as road surface data, GPS position data, weather data, or the like.

The at least one computing device 20 may receive sensor data from the plurality of sensors 46 and on-board sources. The at least one computing device may process received data via feature extraction 26 via Mel filter banks 28 or continuous wavelet transforms 30 in addition to other feature extraction methods 32. process data may be communicated to a pre trained machine learning model 34 constructed and arranged to classify road type 36, generate a mu value 38, and generate tire wear warnings in a vehicle. Road type 36 and mu value 38 may further be processed to qualify the mu value 38 based on assessment of chassis performance. The mu value 38 may further by processed 44 and compared to historical data relating to a vehicles current location as determined by GPS or received via the network 22 to generate a road surface classification 42 and to generate a refined mu value 44.

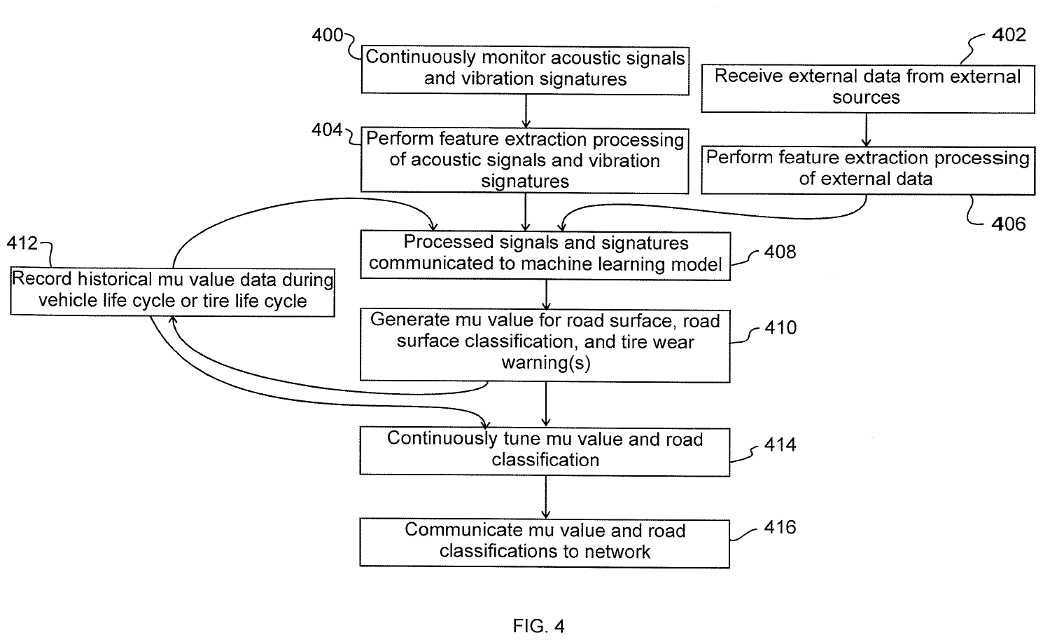

Referring to FIG. 4, as a non-limiting example, a flowchart for an illustrative variation of a vibration-based mu detection system is depicted. Many of the steps in this illustrative variation may be performed cyclically or out-of-turn from the illustrative depiction of FIG. 4. According to step 400, the vibration-based mu detection system may include vehicle level signals monitoring actuation behavior, vehicle environment, vehicle dynamics, and other vehicle system states. Vehicle travel data such as, but not limited to, wheel speed, temperature, vibration or pressure data, vehicle speed, acceleration, yaw or pitch data, braking data such as temperature, handwheel angle, position or torque data, pinion torque or angle data, rack force, imaging data from optical devices such as, but not limited to, optical sensors or cameras, or any other data relevant to the aspects of travel for a vehicle may be continuously collected throughout all of the steps. At step 402, external data such as, but not limited to, GPS vehicle location, weather data, road surface data, V2X data, or the like may be continuously collected throughout all of the steps starting at step 402. In step 404, the system may perform feature extraction based on vehicle level signals collected in step 400 and communicate transformed and processed vehicle travel data to a machine learning model in step 408. In step 406, the system may perform feature extraction processing of the external data collected in step 402 and communicate transformed and processed external data to a machine learning model in step 408. In some instances, vehicle travel data and external data may be combined prior to performing feature extraction on a single set of data. In some instances, external data may be pre-processed via feature extraction outside of the system before being provided to the machine learning model. In step 410, processed vehicle travel data and external data may be used to generate an estimated mu value for a road surface, and in particular for the road surface on which a vehicle may be currently traveling or which a vehicle may be approaching. The system may further generate a road surface classification and estimate vehicle tire wear based on vehicle travel data and external data. In step 412, the generated mu value, road surface classification, or tire wear estimation may be recorded as historical data for estimating vehicle life cycle or tire life cycle. Historical data may also be communicated to the machine learning model and incorporated into the vehicle travel data and external data such that mu value, road surface classification, and tire wear may be more accurately measured and estimated. In step 414, mu value estimation, road classification, and tire wear may be continuously tuned or adjusted based on historical data and continuously received vehicle travel data and external data. In step 416, mu value estimation road classification, in addition to historical data, vehicle travel data, and external data, may be communicated to a network in operable communication with the system such that said data may be communicated to other vehicles implementing the system to further facilitate accurate estimation of mu value and road classification across a plurality of vehicles.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

According to variation 1, a method of mu estimation may include collecting vehicle travel data on a road surface via a plurality of a sensors; performing feature extraction processing of the vehicle travel data to transform the vehicle travel data into processed vehicle travel data; communicating the processed vehicle travel data to a machine learning model; and generating at least one of an estimated mu value of the road surface or road surface classification via the machine learning model.

Variation 2 may include a method as in variation 1 wherein collecting vehicle travel data via a plurality of a sensors is approximately continuous.

Variation 3 may include a method as in any of variations 1 through 2 further including collecting external source data over a network prior to performing feature extraction processing of the vehicle travel data.

Variation 4 may include a method as in any of variations 1 through 3 wherein collecting external source data over a network prior to performing feature extraction processing of the vehicle travel data is approximately continuous.

Variation 5 may include a method as in any of variations 1 through 4 wherein performing feature extraction processing of the vehicle travel data to transform the vehicle travel data into processed vehicle travel data further includes performing feature extraction processing of the external source data to transform the external source data into processed external source data.

Variation 6 may include a method as in any of variations 1 through 5 wherein communicating the processed vehicle travel data to a machine learning model further includes communicating processed external data to the machine learning model.

Variation 7 may include a method as in any of variations 1 through 6 wherein external source data includes at least one of GPS vehicle location, weather data, road surface data, or V2X data.

Variation 8 may include a method as in any of variations 1 through 7 wherein the plurality of sensors includes at least one of an accelerometer, a microphone constructed and arranged for acoustic pressure sensing, a contact sensor system, or a tire pressure monitoring system.

Variation 9 may include a method as in any of variations 1 through 8 further including recording estimated mu value as historical data over time and communicating the historical data to the machine learning model to further facilitate accurate generation of the estimate mu value of the road surface.

Variation 10 may include a method as in any of variations 1 through 9 wherein vehicle travel data includes at least one of wheel speed, temperature, vibration or pressure data, vehicle speed, acceleration, yaw or pitch data, braking data, handwheel angle, position or torque data, pinion torque or angle data, rack force, or imaging data.

According to variation 11, a method of mu estimation may include the steps of approximately continuously collecting vehicle travel data on a road surface via a plurality of a sensors including at least one of an accelerometer or microphone; approximately continuously collecting external source data over a network; aggregating the vehicle travel data and external source data to form an aggregated data set; performing feature extraction processing of the aggregated data set to transform the aggregated data set and into a processed aggregated data set; communicating the processed aggregated data set to a machine learning model; and generating at least one of an estimated mu value of the road surface or road surface classification via the machine learning model.

Variation 12 may include a method of mu estimation as in variation 11 wherein vehicle travel data includes at least one of wheel speed, temperature, vibration or pressure data, vehicle speed, acceleration, yaw or pitch data, braking data, handwheel angle, position or torque data, pinion torque or angle data, rack force, or imaging data.

Variation 13 may include a method of mu estimation as in any of variations 11 through 12 wherein external source data includes at least one of GPS vehicle location, weather data, road surface data, or V2X data.

Variation 14 may include a method of mu estimation as in any of variations 11 through 13 wherein the plurality of sensors includes at least one of an accelerometer, a microphone constructed and arranged for acoustic pressure sensing, a contact sensor system, or a tire pressure monitoring system.

Variation 15 may include a method of mu estimation as in any of variations 11 through 14 further including recording estimated mu value as historical data over time and communicating the historical data to the machine learning model to further facilitate accurate generation of the estimate mu value of the road surface.

According to variation 16, a product for vibration base mu estimation may include at least one computing device in operable connection with a network; a memory that stores computer-executable components; a processor that executes the computer-executable components stored in the memory. The computer-executable components may include approximately continuously collecting vehicle travel data on a road surface via a plurality of a sensors; approximately continuously collecting external source data over the network; performing feature extraction processing of the vehicle travel data and external source data to transform the vehicle travel data and external source data into processed vehicle travel data and processed external source data; communicating the processed vehicle travel data and processed external source data to a machine learning model; and generating at least one of an estimated mu value of the road surface or road surface classification via the machine learning model.

Variation 17 may include a product for vibration base mu estimation as in variation 16 further including qualifying the estimated mu value based on an assessment of vehicle chassis performance.

Variation 18 may include a product for vibration base mu estimation as in any of variations 16 through 17 further including recording estimated mu value as historical data over time and communicating the historical data to the machine learning model to further facilitate accurate generation of the estimate mu value of a road surface.

Variation 19 may include a product for vibration base mu estimation as in any of variations 16 through 18 further including communicating historical data over the network to at least one other computing device.

Variation 20 may include a product for vibration base mu estimation as in any of variations 16 through 19, wherein the at least one other computing device is in operable communication with a vehicle.

The above description of select variations within the scope of the invention is merely illustrative in nature and, thus, variations or variants thereof are not to be regarded as a departure from the spirit and scope of the invention.

What is claimed is:

1. A method comprising:
collecting vehicle travel data on a road surface via a plurality of a sensors;
performing feature extraction processing of the vehicle travel data to transform the vehicle travel data into processed vehicle travel data;
communicating the processed vehicle travel data to a machine learning model; and
generating at least one of an estimated mu value of the road surface or road surface classification via the machine learning model.

2. The method of claim 1, wherein collecting vehicle travel data via a plurality of a sensors is approximately continuous.

3. The method of claim 1, further comprising collecting external source data over a network prior to performing feature extraction processing of the vehicle travel data.

4. The method of claim 3, wherein collecting external source data over a network prior to performing feature extraction processing of the vehicle travel data is approximately continuous.

5. The method of claim 4, wherein performing feature extraction processing of the vehicle travel data to transform the vehicle travel data into processed vehicle travel data further comprises performing feature extraction processing of the external source data to transform the external source data into processed external source data.

6. The method of claim 5, wherein communicating the processed vehicle travel data to a machine learning model further comprises communicating processed external data to the machine learning model.

7. The method of claim 6, wherein external source data comprises at least one of GPS vehicle location, weather data, road surface data, or V2X data.

8. The method of claim 1, wherein the plurality of sensors comprises at least one of an accelerometer, a microphone constructed and arranged for acoustic pressure sensing, a contact sensor system, or a tire pressure monitoring system.

9. The method of claim 1, further comprising recording estimated mu value as historical data over time and communicating the historical data to the machine learning model to further facilitate accurate generation of the estimate mu value of the road surface.

10. The method of claim 1, wherein vehicle travel data comprises at least one of wheel speed, temperature, vibration or pressure data, vehicle speed, acceleration, yaw or pitch data, braking data, handwheel angle, position or torque data, pinion torque or angle data, rack force, or imaging data.

11. A method comprising:
approximately continuously collecting vehicle travel data on a road surface via a plurality of a sensors comprising at least one of an accelerometer or microphone;
approximately continuously collecting external source data over a network;
aggregating the vehicle travel data and external source data to form an aggregated data set;
performing feature extraction processing of the aggregated data set to transform the aggregated data set and into a processed aggregated data set;
communicating the processed aggregated data set to a machine learning model; and
generating at least one of an estimated mu value of the road surface or road surface classification via the machine learning model.

12. The method of claim 11, wherein vehicle travel data comprises at least one of wheel speed, temperature, vibration or pressure data, vehicle speed, acceleration, yaw or pitch data, braking data, handwheel angle, position or torque data, pinion torque or angle data, rack force, or imaging data.

13. The method of claim 11, wherein external source data comprises at least one of GPS vehicle location, weather data, road surface data, or V2X data.

14. The method of claim 11, wherein the plurality of sensors comprises at least one of an accelerometer, a microphone constructed and arranged for acoustic pressure sensing, a contact sensor system, or a tire pressure monitoring system.

15. The method of claim 11, further comprising recording estimated mu value as historical data over time and communicating the historical data to the machine learning model to further facilitate accurate generation of the estimate mu value of the road surface.

16. A product comprising:
at least one computing device in operable connection with a network;
a memory that stores computer-executable components;
a processor that executes the computer-executable components stored in the memory, wherein the computer-executable components comprise:
approximately continuously collecting vehicle travel data on a road surface via a plurality of a sensors;
approximately continuously collecting external source data over the network;
performing feature extraction processing of the vehicle travel data and external source data to transform the vehicle travel data and external source data into processed vehicle travel data and processed external source data;
communicating the processed vehicle travel data and processed external source data to a machine learning model; and
generating at least one of an estimated mu value of the road surface or road surface classification via the machine learning model.

17. The method of claim 16, further comprising qualifying the estimated mu value based on an assessment of vehicle chassis performance.

18. The method of claim 16, further comprising recording estimated mu value as historical data over time and communicating the historical data to the machine learning model to further facilitate accurate generation of the estimate mu value of a road surface.

19. The method of claim 18, further comprising communicating historical data over the network to at least one other computing device.

20. The method of claim 19, wherein the at least one other computing device is in operable communication with a vehicle.
